(19) United States
(12) Patent Application Publication
(10) Pub. No.: US 2007/0026154 A1
(43) Pub. Date: Feb. 1, 2007

(54) Method for producing damage resistant multi-layer coating on an automotive body or part thereof

(76) Inventors: Ayumu Yokoyama, Clarkston, MI (US); Basil V. Gregorovich, Wilmington, DE (US); Robert R. Matheson, West Bloomfield, MI (US); Li Lin, Wallingford, PA (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/493,062

(22) Filed: Jul. 26, 2006

Related U.S. Application Data
(60) Provisional application No. 60/704,144, filed on Jul. 29, 2005.
(60) Provisional application No. 60/704,114, filed on Jul. 29, 2005.

(51) Int. Cl. B05D 3/02; B05D 1/36

(52) U.S. Cl. 427/372.2; 427/402

(57) ABSTRACT

This invention relates to a method for maximizing the stone chipping resistance and scratch resistance of a multi-layer finish on an automotive substrate. A colored basecoat is applied to the substrate and directly on top of the basecoat is applied a protective clearcoat having a fracture resistance about equal to or above 26 mN and a plastic deformation resistance about equal to or above 30 mN/μm. The resultant coating in addition to being durable to the elements and having excellent appearance produces a finish with an outstanding balance of scratch and stone chip resistance after application.

### CROSS-REFERENCE TO RELATED APPLICATION

This application claims priority under 35 U.S.C. § 119 from U.S. Provisional Application Ser. Nos. 60/704,144, filed Jul. 29, 2005 (FA1148 USPRV) and 60/704,114, filed Jul. 29, 2005 (FA1478 USPRV).

### FIELD OF THE INVENTION

The present invention relates to a method for producing a damage resistant multi-layered coating on an automotive body or part thereof and in particular to a method for maximizing both stone chipping resistance and scratch resistance of a multi-layer coating used for finishing automobile and truck bodies.

### BACKGROUND OF THE INVENTION

Coating systems for automobiles normally comprise a multiplicity of coatings applied to a steel substrate. Typically, the steel is treated with a rust-proofing phosphate layer, then a cathodic electrocoat primer for additional corrosion protection is applied. A primer-surfacer is used next to smooth the surface and provide a thick enough coating to permit sanding to a smooth, flat finish. Then a top-coat system is applied, sometimes as a single colored coat, more often now as a basecoat with solid color or flake pigments followed by a transparent protective clearcoat, to protect and preserve the attractive aesthetic qualities of the finish on the vehicle even on prolonged exposure to the environment or weathering.

Automobile manufacturers, in their efforts to extend the expected life of automobile finishes, have directed considerable attention to various processes and compositions designed to result in both improved scratch resistance and improved stone impact (stone-chip) resistance properties. Consumers not only prefer an automotive exterior finish having an attractive aesthetic appearance, including high gloss and excellent DOI (distinctness of image), but also they desire a long-lasting finish with excellent durability. However, mar and scratch resistance of the clearcoat have been a continuing problem, which can detract from the overall appearance. Marring or scratching of the finish can be caused by mechanical washing procedures used in a typical commercial car wash or by other mechanical marring of the finish. Chipping has also been another continuing problem for automotive coating systems. Stones and debris can cause chipping of the paint, particularly in the front hood and fender area and also the lower area of the car including the rocker panels.

There have been extensive research and development efforts directed to providing clearcoat compositions that have improved scratch and mar resistance, while also meeting today's performance requirements such as excellent appearance and weatherability. However, persons skilled in the art have not been able to find mechanical properties of the clearcoat that can well predict stone impact or chip resistance for the multi-layer automotive finish. Stone chip resistance has therefore been looked at independently over the years. It has been recognized in the industry as a composite property involving all paint layers, and improvement has been accomplished by much trial and error, with the focus centered on improving the softness, or rubber-like properties and reducing the brittleness of the primer-surfacer layer. Nowadays, the bulk of the responsibility for providing improved chip resistance lies with the primer surfacer layer. It is not necessarily desirable, however, to look at chip resistance and scratch resistance properties separately.

A goal has therefore been to find a convenient method to maximize both the scratch resistance and stone chipping resistance of automotive coating systems by looking to the mechanical properties of only one of the coating layers, specifically to the mechanical properties of the outermost clearcoat layer, in order to optimize the performance of multi-layer automotive coating systems.

### SUMMARY OF THE INVENTION

Disclosed herein is a method for providing a chip resistant and scratch resistant multi-layer coating, said method comprising:

applying a pigmented basecoat onto a substrate;

applying a clearcoat over said basecoat; and

curing said clearcoat by baking for a sufficient time at a suitable temperature to produce a multi-layer coating having fracture resistance about equal to or greater than 26 mN and a plastic deformation resistance about equal to or greater than 30 mN/μm.

### BRIEF DESCRIPTION OF THE DRAWINGS

FIG. 1 is a rendition of a 3-dimensional atomic force micrograph (AFM) of a micro-scratch produced during plastic deformation of a coating film.

FIG. 2 is a rendition of a 3-dimensional AFM of a micro-scratch produced during fractured deformation of a coating film.

FIGS. 3, 4 and 5 are graphs showing the results of a typical micro-scratch experiment obtained using the surface scratch test apparatus disclosed in Lin U.S. Pat. No. 6,520,004.

FIGS. 6 and 7 are graphs showing the effects of clearcoat fracture resistance and plastic deformation resistance on chip count of a multi-layered automotive finish.

### DETAILED DESCRIPTION OF THE INVENTION

The present invention now provides a method to maximize both the stone chip resistance and scratch resistance of a multi-layer automotive coating system by looking to the mechanical properties, i.e., the fracture resistance and plastic deformation resistance, of the clearcoat layer alone. The method is particularly useful for finishing the exterior of automobiles and trucks and parts thereof.

The behavior of the clearcoat defined above ensures excellent scratch resistance (much higher than typical specifications: a fracture resistance of 15 mN and a plastic deformation resistance of 15 mN/μ) and excellent chip resistance (a minimum rating of 7 using ASTM D3170-03).

Also included within the scope of this invention are coating materials and in particular a clearcoat composition that is capable of forming a cured coating film that is flexible and tough and enables the preparation of multi-layer coatings with an excellent balance of stone-chip and scratch resistance, and a substrate, such as a vehicle body or part thereof, coated with the above composition and/or by process disclosed herein.

As used herein “fracture resistance” means the ability of a material to resist rupturing, breaking and cracking. For automotive coatings, high fracture resistance translates to a coating having good scratch resistance. In the present invention, it has been found that bulk measurements of fracture resistance do not correlate with scratch resistance. Therefore, measurement of surface fracture is needed for purposes of this invention, and such a method is discussed in detail in U.S. Pat. No. 6,520,004. In the present invention, a 2 μm diamond indentor tip is used for measurements.

“Plastic deformation resistance” or “plastic flow resistance” means the ability of a material such as a plastic to resist fluid movement or deformation that is proportional to the pressure in excess of a certain minimum pressure (yield value) to begin the flow. For automotive coatings, plastic flow resistance is a way to determine mar resistance of the cured coating film. Room temperature plastic flow is referred to as “creep” and at elevated temperature plastic flow is referred to as “melt flow”. However, in the present invention, as with fracture resistance, plastic flow resistance measured by the bulk methods described above, do not correlate with mar resistance. Measurement of surface plastic flow resistance is therefore needed, for purposes of this invention, and such a method is discussed in detail below and further described in Lin U.S. Pat. No. 6,520,004, previously incorporated by reference herein, except using a 2 μm diamond indentor tip.

“Scratch resistance” or “mar resistance” means the ability of a coating to resist physical damage on its surface in the form of many fine lines (scratches or mars) resulting from contact with a hard material such as sand or grit often in a carwash where the material is dragged over the surface. As will be discussed below, a combination of two tests is needed to characterize scratch and mar resistance of automotive coatings. These tests are test method ASTM D6037(1)23 “Dry Abrasion Mar Resistance” and test method ASTM D5178(1)23 “Mar Resistance”. The development of tests for scratch and mar performance of coatings and correlation with commercial performance is detailed in B. V. Gregorovich and P. J. McGonigal, “Scratch and Mar of Automotive Clearcoats”, Finishing ′93, Cincinnati, Ohio (1993).

“Chip resistance” means the ability of a coating system to resist physical damage from impact of a hard material most commonly stones or gravel which are thrown against the vehicle by the wheels of passing cars, or in the case of rocker panels thrown up against the car by the wheels of the same car. A suitable test for chip resistance is a gravelometer test such as test method ASTM D3170-03 “Standard Test Method for Chipping Resistance of Coatings” which is essentially the same as SAE J-400, variations of which are favored by automotive companies. A minimum rating of 7 is desirable for automotive use.

The present invention provides a method for maximizing both scratch and chip resistance of multi-layer coatings, particularly multi-layer coatings used as an exterior finish on automobile and truck bodies or parts thereof. More particularly, it provides a process for coating the exterior of an automotive substrate such as an auto or truck body or parts thereof with a multi-layer coating, which imparts to the coating an outstanding balance of chip resistance and scratch resistance, while at the same time providing a finish that is of automotive quality and appearance. The present invention is based on the discovery of a correlation between the mechanical properties of a clearcoat layer and the stone-chip resistance of the multi-layer coating.

Scratch Damage to Coatings

Basecoat/clearcoat multi-layer coating systems first started to replace single coat topcoats for automobiles in the early 1980's. The superior appearance of such systems, particularly their high gloss and excellent distinctness of image (DOI), has led to almost total conversion of automotive topcoats to basecoat/clearcoat systems. The initial excellent appearance of such systems resulted, however, in difficulties maintaining that appearance in use. Scratches and mars are much more visible on such coatings thus leading to customer dissatisfaction sometimes after even a short period of use. Of particular concern to the automotive manufacturers was that a major cause of scratches and mars was car washing, particularly commercial car washing. Thus damage resulted from a normal operation that the car owner performed not an abusive or accidental event so that virtually all cars suffer some degree of damage.

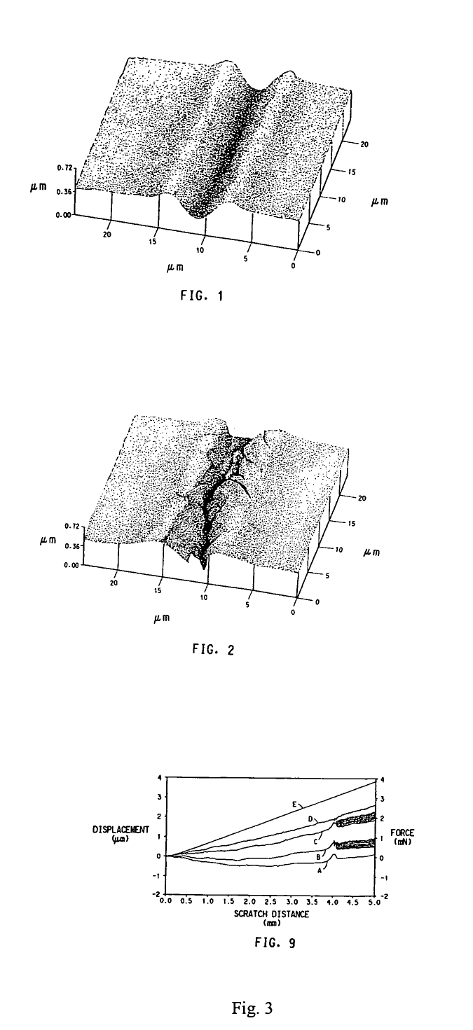

Physical and mechanical properties of such coatings have been studied to determine the properties needed for improved performance (B. V. Gregorovich and P. J. McGonigal, “Mechanical Properties of Coatings Needed for Good Scratch and Mar”, Proceedings of the ACT conference, Chicago, 1992). It was discovered that there is a dual mechanism for scratch and mar failure of coatings: fracture and plastic flow. All coatings show some degree of both types of failure. These two types of failure are shown in FIG. 1 herein which shows plastic flow damage and FIG. 2 herein which shows brittle fracture damage.

Strict definition would suggest that fracture results in scratch damage and plastic flow results in mar damage. Unfortunately the nature of the damage can only be determined with a microscope. Since the distinction cannot be made visually we will follow conventional usage which is that the terms scratch and mar are equivalent and each one refers independently to a mix of damage, both fracture and plastic flow. We will subsequently use the term scratch damage to refer to both types of damage.

The two types of scratch damage result from different physical responses to applied forces. All coating materials respond to physical attack by elastic recovery, plastic flow and fracture. The degree of response and ability of a coating to resist permanent damage from plastic flow and fracture depends on the chemistry and architecture of the coating structure as determined by elements such as the types of polymers used, the type and degree of crosslinking and the presence of elastic and inelastic dispersed particles. To improve scratch resistance of a coating it is necessary to improve resistance to both parts of the dual mechanism of scratch damage, that is resistance to plastic flow and resistance to brittle fracture. Different characteristics are needed to improve performance for each type of damage and coupled with the complexity of the elements available that affect the scratch resistance of coatings it became evident that improved means of characterizing damage was necessary.

A test apparatus and procedure for quantitative characterization of scratch behavior of films or coatings, more particularly automotive coatings was developed based on a single scratch device. The apparatus includes a micro-indentor that penetrates and scratches the coating to be characterized together with interrelated components for measuring the force applied, the length and depth of the indentor penetration, the geometry of the disturbed coating surface as well as a system for measuring, analyzing and comparing test results. The apparatus construction is shown in FIGS. 3 to 8 of U.S. Pat. No. 6,520,004 issued to Lin on Feb. 18, 2003 and also in the detailed description from Column 3, line 35 to Column 7 line 24 thereof. The procedure for using the apparatus to determine scratch characteristics is detailed in Column 7 line 25 to Column 8 line 14 of the same patent.

The results from three different clearcoats tested by using the method of and apparatus of patented invention U.S. Pat. No. 6,520,004 are shown in FIGS. 3, 4 and 5 hereof. Indentor with a diamond tip having a 1 μm was used.

Trace A in the graphs of FIGS. 3, 4 and 5 represents the pre-scratch profile of an undamaged surface of the test sample, trace D represents the tip-displacement profile of the tip of indentor as it penetrates into test sample over the set distance, trace B represents the post-scratch profile of the scratch. As seen from trace D and trace B, the coating makes a significant recovery after scratching of the surface. Traces E and D are profiles of normal force and tangential force experienced by test sample during the experiment. The damage to coating is obtained by subtracting the pre-scratch profile depth of trace A from post-scratch profile depth of trace B.

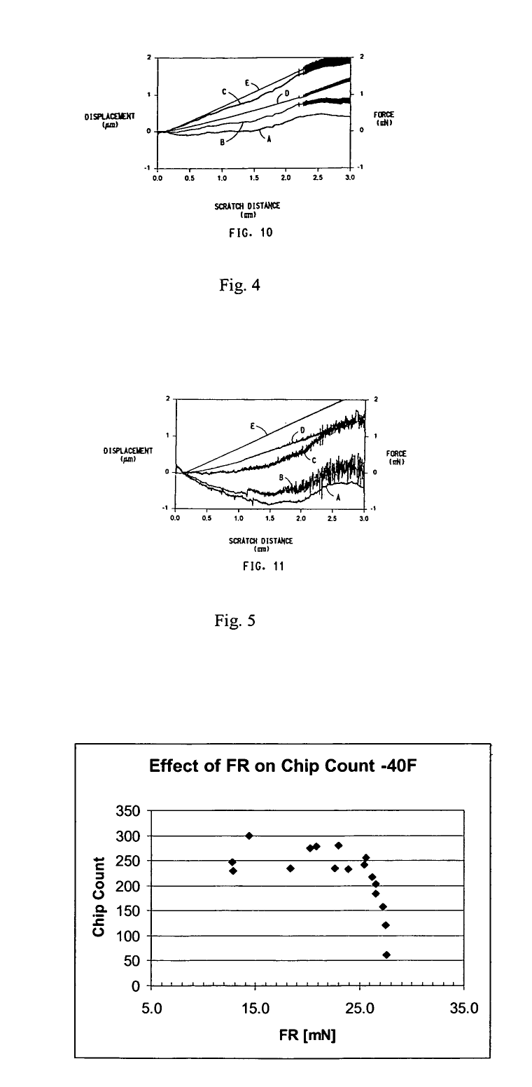

In the early region of the scratch, traces A and B are superimposed, signifying that the deformation of coating is totally recovered, i.e., the deformation was elastic. As the load increased the two traces start diverging, signifying the beginning of visco-plastic deformation, a magnified version can be seen in FIG. 1 hereof. The amount of deformation increased smoothly as the normal force was increased. At a distance of about 4.1 mm in FIG. 3 (normal force of 3 mN) and about 2.15 mm (normal force of 1.8 mN) in FIG. 4, the character of the trace B underwent an abrupt change. The tangential force as shown by trace D profile and tip-displacement profile as shown by trace C started to rapidly fluctuate indicating that a fracture had occurred, a magnified version can be seen in FIG. 2. As the normal load increased further, both the frequency and magnitude of the rupture increased and eventually debris was generated. The third clearcoat shown in FIG. 5 had early onset of very severe brittle fracture indicating poor scratch performance.

As outlined in Lin U.S. Pat. No. 6,520,004, a variety of different measurements that provide useful information can be taken with the single scratch apparatus described. It has been found that at least two measurements which relate to the dual mechanism of scratch damage are needed to characterize the scratch performance of a coating. To characterize fracture damage the force in milliNewtons (mN) at which fracture starts is used and to characterize plastic flow damage, the resistance to plastic flow measured in milliNewtons per micron (mN/μ) is used. Both of these values can be obtained from the experiments described above and shown in FIGS. 3, 4 and 5. The inventors have found herein that a clearcoat having a fracture resistance above 26 mN and a plastic deformation resistance above 30 mN/μm would have exceptional scratch performance.

Chip Damage to Coatings

Damage from hard objects (e.g. stones) impacting vehicles has been an area of concern for automobile manufacturers for a considerable period of time. Previously, it was recognized by persons skilled in the art that the bulk of the responsibility for providing improved chip resistance properties lay with the primer surfacer layer, as for example, as shown in U.S. Pat. No. 4,804,718, issued to Dervan et al. on Feb. 14, 1989. In Dervan et al., considerable research and development efforts are directed to obtaining primer compositions which are flexible and thus chip resistant and which also provide good intercoat adhesion.

Particularly notice that the above patent is directed to improving the primer layer but there is a requirement for good adhesion between the coating layers. Improvement of the primer layer is also illustrated in a paper by Howard S. Bender, “The mechanical properties of films and their relation to paint chipping”, Journal of Applied Polymer Science, Vol 13, Issue 6, Pages 1253-1264 (2003). Finally in U.S. Pat. No. 6,770,705, issued to Vanier et al. on Aug. 3, 2004, there is shown the importance of the interaction between the paint layers but the improvement in chip performance was made by changes to the primer-surfacer layer.

In summary chip performance has been a major concern for automobile and coatings manufacturers for many years and although the importance of intercoat adhesion and the implication that other layers contribute to performance has been known, improvements in performance have focused on the primer layer.

It was therefore surprising and unanticipated to find that the physical characteristics of clearcoat surfaces needed for excellent scratch and mar resistance, fracture resistance at or above 26 mN, in one embodiment from about 26 mN to 500 mN and plastic flow deformation resistance at or above 30 mN/μm, in one embodiment, from about 30 mN/μm to 500 mN/μm, are the same physical properties needed for excellent chip resistance, provided other aspects of the multi-layer system such as good intercoat adhesion have been satisfied. These physical characteristics can be measured by a single scratch device such as the device previously described. A particularly good range for achieving excellent chip performance is a combination of fracture resistance at or above 26 mN and plastic flow deformation resistance at or above 35 mN/μm.

Also, it should be understood that any numerical range recited herein is intended to include all sub-ranges subsumed therein. For example, a range of “26 mN to 500 mN” is intended to include all sub-ranges between (and including) the recited minimum value of 26 mN and the recited maximum value of 500 mN, that is, having a minimum value equal to or greater than 26 mN and a maximum value of equal to or less than 500 mN.

While the broad concept of this invention is applicable to a variety of clearcoat systems that are used nowadays in automotive topcoats, including hydroxyacrylic/melamine, hydroxyacrylic/isocyanate, carbamate/melamine, acrylosilane/melamine, epoxy/acid, and blends thereof, these systems must be properly formulated to provide the above mechanical properties. High fracture resistance which is necessary to achieve both scratch resistance and resistance to chipping is best achieved with a tough flexible material while good plastic flow resistance needed for mar resistance requires a hard more crosslinked system. These requirements can both be met by a film that has suitable crosslinking that provides a more rigid material with sufficient local flexibility to provide the necessary fracture resistance. There are various ways known to provide these properties such as controlling cross-link chemistry, through the use for example of a combination of crosslinkers such as a rigid melamine and a more flexible urethane crosslink, controlling cross-link density through the use of highly functional crosslinkable materials such as hyperbranched polyesters, and glass transition temperature through the proper selection of monomers in acrylics and polyesters. Other means of achieving fracture and plastic flow resistance such as the formation of a toughening phase structure and the use of micro and nano particles of hard materials such as silica and mica can be usefully employed. All of these adjustment techniques are well known to those skilled in the art.

Accordingly, any of a wide variety of commercially available automotive clearcoats used in automotive OEM (original equipment manufacture) and refinish applications may be employed in the present invention, including standard solvent borne, waterborne or powder clears, slurry powder clears, UV clears, 2K clears and the like, which have been adjusted to provide the above desired mechanical properties.

Preferably, the clearcoat composition is a crosslinkable coating comprising at least one crosslinkable film-forming resin and at least one crosslinking material, although non-crosslinkable thermoplastic film-forming materials such as polyolefins can be used instead. Depending on the crosslinking resins employed, the film-forming resin may be included with the crosslinking agent in a single package (1K) system, or added as a separate material in a two package (2K) system, as is well known to those skilled in the art. The clearcoat may also include other usual conventional formulation additives, such as flow control agents, rheology control agents, UV stabilizers, etc.

Sprayable high solids liquid solvent borne clearcoats which have low VOC (volatile organic content) and meet current pollution regulations are generally preferred. Typically useful high solids solvent borne topcoats include 1K clearcoats based on high solids carbamate/melamine or acrylosilane/melamine resins, which are disclosed in U.S. Pat. Nos. 6,607,833; 5,162,426; and 4,591,533, which are incorporated by reference herein, 2K clearcoats based on polyisocyanate disclosed in U.S. Pat. No. 6,544,593, which is incorporated by reference herein and SuperSolids™, very high solids coatings, based on oligomeric silanes disclosed in U.S. Pat. No. 6,080,816, which is incorporated by reference herein. A particularly preferred clearcoat system useful herein comprises, is a very high solids coating, based on a silane acrylic polymer or oligomer, a hyperbranched polyester, a monomeric or polymeric melamine, a polyisocyanate, and hydroxy compounds, as well as other components found in clearcoats such as catalysts, flow additives and UV light stabilizers and screeners, as for example. These compositions are more fully described in U.S. patent application Ser. No. 10/832,749 of Nagata et al., filed on Apr. 27, 2004, which is incorporated by reference herein. As is well known to those skilled in the art, these compositions may be pigmentless or may contain some pigment provided the resulting clearcoat is still substantially transparent.

According to the present invention, any of the above compositions formulated in the manner disclosed herein is useful as a clearcoat on a variety of substrates to prevent both scratching and chipping of the entire multi-layer finish.

Useful substrates that can be coated according to the process of the present invention include metal substrates, polymeric substrates, such as thermoset materials and thermoplastic materials, and combinations thereof. Useful metal substrates that can be coated according to the process of the present invention include ferrous metals such as iron, steel, and alloys thereof, non-ferrous metals such as aluminum, zinc, magnesium and alloys thereof, and combinations thereof. Preferably, the substrate is formed from cold rolled steel, electrogalvanized or hot dip galvanized steel or electrogalvanized iron-zinc steel, aluminum or magnesium. Useful thermoset materials include polyesters, epoxides, phenolics, polyurethanes such as reaction injected molding urethane (RIM) thermoset materials and mixtures thereof. Useful thermoplastic materials include thermoplastic polyolefins such as polyethylene and polypropylene, polyamides such as nylon, thermoplastic polyurethanes, thermoplastic polyesters, acrylic polymers, vinyl polymers, polycarbonates, acrylonitrilebutadiene-styrene (ABS) copolymers, EPDM rubber, copolymers and mixtures thereof.

Preferably, the substrates are used as components to fabricate automotive vehicles, including but not limited to automobiles, trucks, and tractors. The substrates can have any shape, but are preferably in the form of automotive body components such as bodies (frames), hoods, doors, fenders, bumpers and/or trim for automotive vehicles.

In producing a finish of automotive quality on a substrate, as indicated above, multiple layers of coatings are generally used. A typical automobile steel panel or substrate has, for example, several layers of coatings. The substrate is typically first coated with an inorganic rust-proofing zinc or iron phosphate layer over which is provided a corrosion resistant primer which can be an electrocoated primer or a repair primer. A typical electrocoated primer, which is mainly used in OEM applications, comprises an epoxy polyester and various epoxy resins. A typical repair primer for refinish applications comprises an alkyd resin. Optionally, a primer surfacer can be applied over the primer coating to provide better appearance and/or improved adhesion of the basecoat to the primer coat. A pigmented basecoat or colorcoat is next applied over the primer surfacer. A typical basecoat comprises a pigment, which may include metallic flakes in the case of a metallic finish, and polyester or acrylourethane as a film-forming binder. A clearcoat is then applied to the pigmented basecoat (colorcoat). The primer-surfacer, clearcoat and colored basecoat layers are generally considered the top coat system.

According to the present invention, following the application of any rust-proofing pretreatment coating and electrodeposition or repair primer coating on the surface of the automotive substrate and baking, the primer surfacer and top coating system are applied. To build a durable finish with optimal scratch and chip resistance, a suitable primer surfacer, liquid or powder, may then be applied usually by spraying. Electrostatic spraying is generally preferred for all the topcoating layers. Any of a wide variety of commercially available primer surfacers can be employed in the present invention. After application, the primer surfacer is baked to achieve adequate adhesion with the pre-primed substrate. The primer surfacer is typically baked at 120-160° C. for about 15-30 minutes to form a coating about 0.5-3.0 mils thick. As indicated above, the adhesion of the primer to the pre-primed surface is a significant part of achieving the chip resistance properties desired for the overall multi-layer coating system. The adhesion can be measured by a cross-hatch adhesion test (General Motor's, i.e., GM's, test method: GM 9071P) and the adhesion rating should be less than 5% area removed. Any less adhesion could cause the chip resistance to decay, even when the other factors of the clearcoat system outline above are met. Adequate adhesion is needed for good chip resistance. If adhesion is poor, a durable clearcoat prevents only cracking within clearcoat layer but not delamination between the coating layers.

Following application of the primer-surfacer and attaimnent of good adhesion with the pre-treated or pre-primed substrate, the basecoat is then applied followed by application of the clearcoat of this invention. The basecoat may be either a solvent based composition or a waterborne composition. Any of a wide variety of commercially available refinish and OEM basecoats can be employed in the present invention.

The basecoat is first applied over the primer-surfacer and then dried (i.e., typically flash dried at room temperature) to at least remove solvent or water before the clearcoating is applied usually by conventional spraying preferably using a wet-on-wet technique. As indicated above, electrostatic spraying is generally preferred for all the topcoating layers. Following application of the basecoat, the clearcoat is applied by conventional techniques such as spraying, electrostatic spraying, dipping, brushing, flow coating and the like. The preferred techniques are spraying and electrostatic spraying in automotive OEM and refinish applications. The basecoat/clearcoat finish may then be baked to provide a dried and cured finish. For example, after application of the clearcoat in refinish applications, the composition is typically dried and cured at ambient temperatures but can be forced dried at elevated temperatures of 40-100° C. for about 5-30 minutes. For OEM applications, the composition is typically baked at 100-180° C. for about 15-60 minutes. For UV applications, the UV curable composition is exposed to sufficient UV radiation to dry and cure the film and may also be subject to some baking. The basecoat and clearcoat are typically applied to form individual dry coating layers on the substrate surface each about 0.5-3.0 mils thick. It has become customary, particularly in the auto industry, to apply a clear topcoat over the basecoat by means of a “wet-on-wet” application, i.e., the clearcoat is applied to the basecoat without curing or completely drying the basecoat. The coated substrate is then heated for a predetermined time period to allow simultaneous curing of the base and clearcoats.

In summary, after a clearcoat that is formulated according to the present invention and applied as the outermost coating layer over a conventional multi- layer automotive topcoat finish, the present invention provides a multi-layered automotive OEM or refinish exterior finish that has excellent durability with both excellent scratch and chip resistance.

The following examples illustrate the invention. All parts and percentages are on a weight basis unless otherwise indicated. All molecular weights disclosed herein are determined by GPC (gel permeation chromatography) using a polystyrene standard.

### EXAMPLES

The following examples illustrate the invention. All parts and percentages are on a weight basis unless otherwise indicated. Example 1 is a solvent-borne 2K super high solids clearcoat.

Clearcoat Example 1
Preparation of Clearcoat Composition
Example 1

| | |
|---|---|
| | Parts by Weight |
| Ingredients | (grams) |

PART 1

| | |
|---|---|
| Melamine Formaldehyde Resin¹ | 31.46 |
| Hyper-branched Polyester² | 11.95 |
| 2-Ethylhexanol | 0.70 |
| 2-Ethyl-1,3-hexanediol | 1.40 |
| Silane Acrylic³ | 4.63 |
| Microgel Rheology Control Agent⁴ | 1.50 |
| Silica Dispersion Rheology Control Agent⁵ | 0.50 |
| Ultraviolet Screener⁶ | 2.00 |
| Hindered Amine Light Stabilizer⁷ | 1.00 |
| Acid/Amine Catalyst⁸ | 0.70 |
| Bismuth Catalyst⁹ | 0.10 |
| Flow Aid¹⁰ | 0.06 |

PART 2

| | |
|---|---|
| Polyisocyanate¹¹ | 44.00 |
| Total | 100.00 |

Footnotes
¹Cymel ® 1158 melamine supplied by Cytec Industries, West Patterson, New Jersey.
²Hyper-branched Copolyester Polyol Solution prepared in accordance with the procedure described in U.S. Pat. No. 6,861,495 in the Example (Highly Branched Copolyester Polyol-Solution 2) but using the following monomer composition: caprolactone/dimethylol propionic acid/pentaerylthritol 63/32/5 wt. ratio (Mn = 3000).
³Silane Acrylic prepared in accordance with the procedure described in U.S. Pat. No. 6,767,642 but using the following monomer composition: STY/HPA/BA/IBMA/Methacryloxy propyl trimethoxy silane 10/10/3/12/65 wt.
ratio (Mn = 1000).
⁴Microgel prepared in accordance with the procedure described in U.S. Pat. No. 4,849,480, Col 6 lines 12 to 55.
⁵Silica Dispersion prepared in accordance with the procedure described in U.S. Pat. No. 4,238,387, Col 4 lines 5 to 53.
⁶Tinuvin ® 384 supplied by Ciba Specialty Chemicals, Tarrytown, New York.
⁷Tinuvin ® 292 supplied by Ciba Specialty Chemicals, Tarrytown, New York.
⁸Dodecyl benzene sulfonic acid salt of 2-amino-2-methyl-1-propanol supplied by King Industries, Norwalk, Connecticut.
⁹K-Kat ® 348, bismuth carboxylate, supplied by King Industries, Norwalk, Connecticut.
¹⁰Disparlon ® LC955, product of King Industries, Norwalk, Connecticut.
¹¹Desmodur ® N 3400 polyisocyanate supplied by Bayer Corporation, Pittsburgh, Pennsylvania.

For the clearcoat example above, the constituents of Part 1 were charged into a mixing vessel in the order shown above, and mixed until well blended and then discharged to be stored in suitable containers. Just prior to application Part 2 was added to Part 1 in the correct proportion, mixed thoroughly and applied immediately, generally within 30 minutes, to the panels described below. For automotive assembly lines it is typically common at this point to meter the two parts into an inline mixer and spray on a continuous basis.

For the clearcoat prepared above, a phosphatized steel panel was first coated with a primer of a Cormax® 6 electrodeposited primer (from DuPont Company) baked at 188° C. for 20 min., a waterborne primer surfacer (Liquid slurry Primer from DuPont Company used at Ford Dearborn Assembly for F-150 Truck used at Ford Dearborn Assembly for F-150 Truck) baked at 163° C. for 20 min, and a waterborne black basecoat (Ebony Black Waterborne Basecoat from DuPont Company used at Ford Dearborn Assembly for F-150 Truck) prebaked (flashed off) at 82° C. for 5 min to a dry thickness of 15.2 micrometer (0.6 mil). The panel was then topcoated with the clearcoating composition of Example 1 and then bake cured to a dry film thickness of 51 micrometer (2 mil).at various temperatures and time (120° C.-160° C., 10-60 min) to obtain wide range of scratch/mar resistance.

Adequate adhesion of the primer to the pre-electroprimed surface was obtained by using a commercial electrodeposited primer (Cormax® 6 from DuPont Company) and primer surfacer (Liquid Slurry Primer from DuPont Company) system. As discussed above, the adhesion of the primer to the pre-primed surface is significant part of achieving the chip resistance properties desired for the overall multi-layer coating system. The adhesion here is measured by a cross-hatch adhesion test (GM's test method: GM 9071P) and the adhesion rating should be less than 5% area removed. Any less adhesion could cause the chip resistance to decay, even when the other factors of the clearcoat system outline above are met. Adequate adhesion is needed for good chip resistance. If adhesion is poor, durable clearcoat prevents only cracking within clearcoat layer but not delamination between the coating layers. Adequate adhesion is achieved between a cathodic electrodeposition coating primer (Cormax® 6 from DuPont Company), primer surfacer (Liquid Slurry Primer from DuPont Company) and flashed-off black waterborne black basecoat (Ebony Black Waterborne Basecoat from DuPont Company used at Ford Dearborn Assembly for F-150 Truck).

Scratch/mar resistance was obtained using the surface scratch test apparatus disclosed in Lin U.S. Pat. No. 6,520,004, except using a 2 μm diamond indentor tip, which is instrument is commercially available under the: tradename Nano Scratch-Tester from CSM Instruments, Needham, Mass., and chip resistance was obtained with SAE J-400 (3 pints of gravel was shot on panels kept at −40 F at 90-degree angle), which corresponds to ASTM D3170 test method. The number of chips were visually counted.

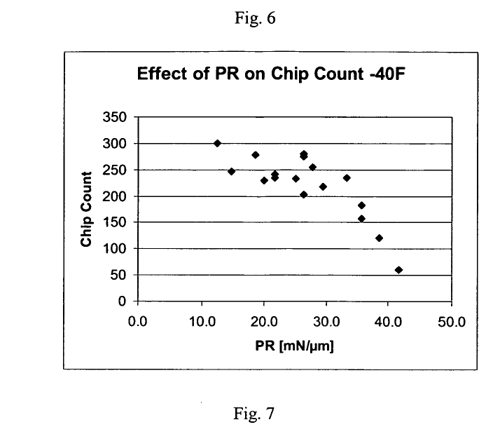

The test results are shown in FIGS. 6 and 7 hereof. The raw data for these figures are reported in Table 1. The experimental conditions for running the Nano-Scratch experiments are reported immediately below the Table.

FIGS. 6 and 7 (data in Table 1 below) show that a good correlation exists between FR (fracture resistance)/PR (plastic deformation resistance) and chip resistance (measured by the number of chipped spots). The clearcoat used here was Example 1 (2K solvent-borne super high solids). FR and PR were varied by changing bake temperatures (120° C.-160° C.). The figures also show that excellent chip resistance can be achieved when FR is at or above 26 mN and PR is at or above 30 mN/μm.

TABLE 1
Effect of Fracture Resistance (FR) and Plastic
Flow Resistance (PR) on Chip Count

| FR | PR | Coating Cure | Coating Cure | |
|---|---|---|---|---|
| [mN] | [mN/μm] | Temperature [F.] | Time [min] | Chip Count |
| 13 | 15 | 121 | 5 | 246 |
| 23 | 33 | 160 | 5 | 234 |
| 23 | 26 | 141 | 20 | 280 |
| 18 | 22 | 121 | 35 | 234 |
| 28 | 42 | 160 | 35 | 61 |
| 25 | 22 | 141 | 5 | 241 |
| 21 | 19 | 121 | 20 | 278 |
| 20 | 26 | 141 | 20 | 274 |
| 26 | 29 | 141 | 20 | 217 |
| 24 | 25 | 141 | 20 | 232 |
| 28 | 39 | 160 | 20 | 120 |
| 26 | 28 | 141 | 35 | 255 |
| 13 | 20 | 121 | 5 | 229 |
| 27 | 36 | 160 | 5 | 183 |
| 27 | 26 | 141 | 20 | 203 |
| 14 | 13 | 121 | 35 | 300 |
| 27 | 36 | 160 | 35 | 157 |

### Nano-Scratch Testing Procedures used in the Example

The following experimental conditions were used for generating the nano-scratch data (FR and PR) reported in the Table above.

Test specimens were tempered at least 24 hr at 73.5°±3.5° F. (23°±2° C.) and a relative humidity of 50±5% and tested under the same conditions. The microscratch fracture experiments (FR) were performed using an indentor size of 2 microns, scratch rate of 3 millimeters per minute, loading rate of 40 mN per minute and scanning preload of 0.2 mN. Three scratches were performed on each speciman at a data acquisition rate of 1.5 μm between data points.

Fracture resistance was determined by locating the point where normal force, tangential force, penetration depth of the indentor and permanent damage began to fluctuate wildly. This is the point where the first fracture occurred. This mechanical quantity is know as the critical load and has units of mN.

The microscratch plastic flow resistance experiments (PR) were performed using the above conditions except for a change in loading rate to 4 mN per minute. Plastic Flow Resistance (PR) was calculated by dividing the normal force by the magnitude of the permanent damage at the normal force just before fracture occurred and is reported in units of mN/μm.

In summary, the test results show that fracture resistance and plastic flow resistance properties of the clearcoat can now be used to predict the stone chip resistance for the multi-layer automotive finish, and also to maximize both the chip performance and scratch resistance of the finish.

Various other modifications, alterations, additions or substitutions of the components of the processes and compositions of this invention will be apparent to those skilled in the art without departing from the spirit and scope of this invention. This invention is not limited by the illustrative embodiments set forth herein, but rather is defined by the following claims.

What is claimed is:

1. A method for providing a chip resistant and scratch resistant multi-layer coating, said method comprising:
applying a pigmented basecoat onto a substrate;
applying a clearcoat over said basecoat;
curing said clearcoat of the basecoat/clearcoat by baking for a sufficient time at a suitable temperature to produce a multi-layer coating having fracture resistance about equal to or greater than 26 mN and a plastic deformation resistance about equal to or greater than 30 mN/μm.

2. The method of claim 1 wherein the substrate is a vehicle body or part thereof.

3. The method of claim 1 wherein the clearcoat is a hydroxyacrylic/melamine, hydroxyacrylic/isocyanate carbamate/melamine, acrylosilane/melamine, epoxy/acid, and blends thereof clearcoat composition.

4. The method of claim 1 wherein the clearcoat comprises a polyisocyanate, melamine, silane acrylic polymer, and hydroxy functional hyperbranched polyester.

5. The method of claim 1 wherein the substrate is pre-primed with an electrodeposition primer and primer surfacer thereover, such that the crosshatch adhesion rating between the primer surfacer and underlying electrodeposited primer is less than 5% area removed.

6. The multi-layer coating obtained by the method of claim 1.

7. The multi-layer coating obtained by the method of claim 5.

8. The multilayer coating of claim 7 wherein the coating is an exterior finish for automobiles and trucks.
